(19) United States
(12) Patent Application Publication
(10) Pub. No.: US 2019/0028767 A1
(43) Pub. Date: Jan. 24, 2019

(54) SYSTEM AND METHOD FOR LIVE EVENT NOTIFICATION

(71) Applicant: Michael Larsuel, Los Angeles, CA (US)

(72) Inventor: Michael Larsuel, Los Angeles, CA (US)

(21) Appl. No.: 16/038,971

(22) Filed: Jul. 18, 2018

Related U.S. Application Data
(60) Provisional application No. 62/534,124, filed on Jul. 18, 2017.

(51) Int. Cl. H04N 21/472; H04N 21/2187; H04N 21/488

(52) U.S. Cl. CPC H04N 21/47214; H04N 21/4882; H04N 21/2187

(57) ABSTRACT

A system for providing a notification of a live event includes a computer system having a memory configured to store program instructions and a processor configured to execute the program instructions. The computer system, in response to execution of the program instructions, is configured to receive live event information regarding the live event, analyze the received live event information, determine a delay status of the live event, generate a message based on the delay status and transmit the generated message. A client device is communicably connected to the computer system and is configured to receive the generated message. The client device includes an output device configured to output a notification based on the generated message.

### BACKGROUND

The following description relates to systems and methods for providing a notification of a live event, and in particular, electronic notification regarding commencement, conclusion, delays, resumption or updates of a live event.

During live television broadcasts, expected and unexpected delays may occur. For example, in a live television broadcast of a sporting event, expected delays may be a result of halftime or intermissions between periods, timeouts, or player substitutions. Unexpected delays include, for example, delays resulting from inclement weather, power outages, player injuries or equipment malfunctions. The television network broadcasting the event often shows one or more commercials during such delays.

Expected delays may occur for a predetermined length of time, and in some cases, at predetermined times or intervals. Unexpected delays typically occur at unpredictable times and last for indeterminate lengths of time. During delays, both expected and unexpected, a viewer of the live event on television may tend to other tasks or switch to a different television event or program. However, doing so may cause the viewer to miss portions of the original live event that went into the delay. In order to avoid such a scenario, the viewer must frequently check the status of the live event. However, this may be tedious and negatively affect the viewer's ability to tend to other tasks or watch other programs during the delay.

Currently, various mobile applications, websites and related services may provide real time or substantially real time updates of live events, such as sporting events. For example, known systems may provide pitch-by-pitch updates of a baseball game, or play-by-play updates during a basketball or football game. Known systems may also provide updates regarding the score of a sporting event and player statistics. Known system may also provide updates regarding schedule information including start time, date and venue. Such systems may also indicate the time remaining in period, quarter, half or full time of a live sporting event, or that a period, quarter, half or full time has ended. The systems may provide an indication or alert to a user that a specific event is about to start. However, such systems do not actively alert a user of a start or end of a delay. Thus, a user needs to continuously monitor such systems to be alerted of the start or end of a delay, and may not tend to other tasks or follow different events during a delay.

Accordingly, it is desirable to provide a method and system for electronically notifying a user of a resumption of a live television event after a delay in the event.

### SUMMARY

According to one aspect, a system for providing a notification of a live event includes a computer system having a memory configured to store program instructions and a processor configured to execute the program instructions, wherein the computer system, in response to execution of the program instructions, is configured to receive live event information regarding the live event, analyze the received live event information, determine a delay status of the live event, generate a message based on the delay status, and transmit the generated message. The system further includes a client device communicably connected to the computer system and configured to receive the generated message. The client device includes an output device configured to output a notification based on the generated message.

In one embodiment, the computer system may be further configured to receive a request to monitor the live event. In one embodiment, the computer system may be further configured to monitor the received live event information.

In one embodiment, the computer system may be configured to store one or more rules for analyzing the live event information and the delay status may be determined at least in part on the basis of the one or more rules. In one embodiment, the computer system may be further configured to store additional information associated with the live event information, and the delay status may be further determined at least in part on the basis of the additional information.

In one embodiment, the live event information may be stored in a plurality of data fields, and the plurality of data fields may include one or more of data fields containing current status information and data fields containing continuous information.

In one embodiment, the system may further include a data source, and the computer system may be configured to receive the live event information from the data source.

In one embodiment, the delay status may indicate that a delay in a live event has ended or that the live event has resumed.

In one embodiment, the client device may be operably connected to, or includes, a tuning module configured to change a channel in response to receiving the generated message.

In one embodiment, the client device may be a portable electronic device, such as a mobile phone or smart phone, a tablet or a laptop computer. In one embodiment the output device may be a display device, an audio device or a tactile device such as a vibrating device.

In one embodiment, the client device may be a set top box such as a cable or satellite receiver, a television, a streaming device, a home AI system, or a gaming console.

According to another aspect, a computer system for determining a delay status of a live event includes a memory configured to store program instructions, a processor configured to execute the program instructions, a receiving module configured to receive live event information regarding the live event, and a determining module configured to analyze the live event information and determine a delay status of the live event. In one embodiment, the computer system may also include a message generating module configured to generate a message based on the determined delay status, and an output module configured to transmit the generated message. Thus, in one embodiment, the computer system may be configured to provide a notification regarding a live event.

In one embodiment, the computer system may further include a rules module configured to store one or more rules for analyzing the live event information and additional information associated with the live event information.

In one embodiment, the determining module may be further configured to determine a start or end of a delay based on the additional information.

In one embodiment, the live event information may be stored in a plurality of data fields, and the plurality of data fields may include one or more of data fields containing current status information and data fields containing continuous information.

In one embodiment, the computer system may further include a request module configured to receive a request to monitor the live event and a monitoring module configured to monitor the received live event information.

According to another aspect, there is provided a method for providing a delay status of a live event, the method executable by a computer system having a processor and a memory, the method including receiving live event information regarding a live event, analyzing the received live event information, and determining a delay status of the live event based on the received live event information. In one embodiment, the method may further include generating a message based on the determined delay status, and transmitting the generated message to a client device. Thus, in one embodiment, the method may include providing a notification regarding the live event.

In one embodiment, analyzing the live event information may further include comparing the live event information to one or more rules stored in a rules module, and the determined delay status may be further based on the one or more rules. In one embodiment, analyzing the live event information may further include analyzing additional information associated with the live event information, and the determined delay status may be further based on the additional information. In one embodiment, the method may further include monitoring the received live event information, and the determined delay status is based on the monitored live event information.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a block diagram showing an example of a system for providing status notifications of live events according to an embodiment;

FIG. 2 is a block diagram of a client device according to an embodiment;

FIG. 3 is a block diagram showing an example of a method of providing a delay status of a live event according to an embodiment; and

FIG. 4 is a block diagram showing an example of a method of providing a live event notification according to another embodiment.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

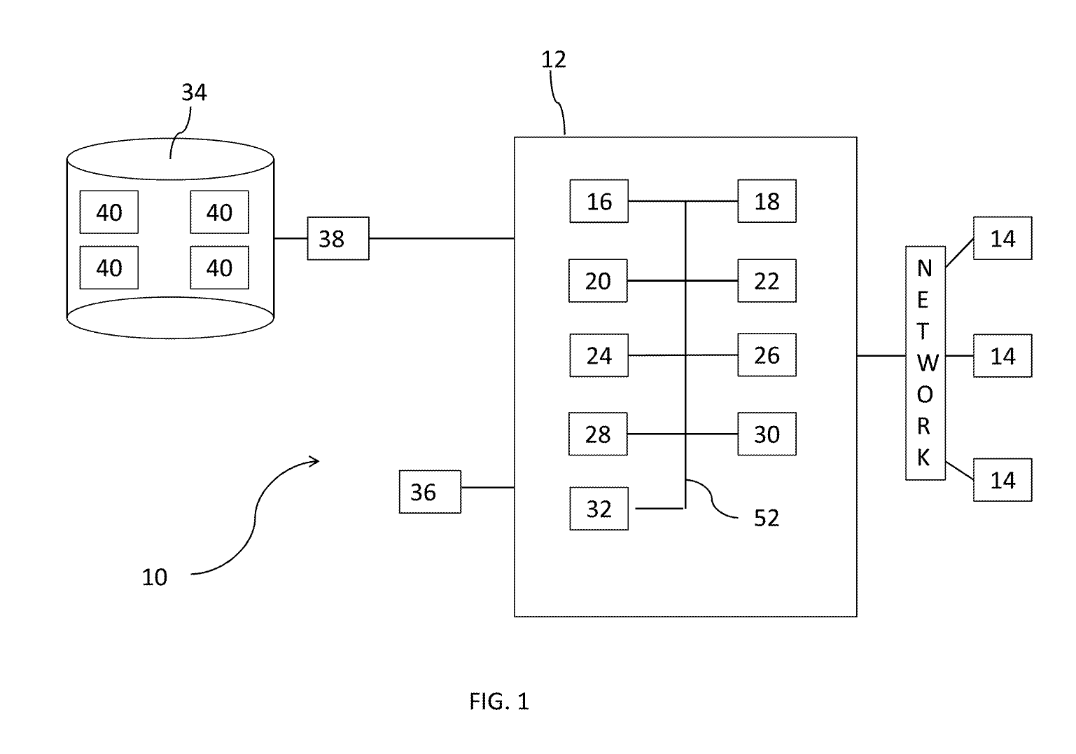

FIG. 1 is a block diagram showing a system 10 for providing a notification regarding a live event, according to an embodiment described herein. The notification may indicate, for example, one or more of a delay status such as the commencement of a delay, an end of the delay or a resumption of the live event, commencement of the live event at a scheduled time, and updates during the live event.

The system 10 generally includes a computer system 12 communicably connected to one or more client devices 14. The computer system 12 and the one or more client devices 14 may be connected over a communication network via known wired or wireless connections. For example, the computer system 12 and the one or more client devices 14 may be connected over the Internet using known protocols or standards, or via a mobile communication network using known protocols or standards.

In one embodiment, the computer system 12 may operate as a server or as a client-user computer in a server-client user network environment, or as a peer computer system in a peer-to-peer distributed network environment. The computer system 12 may also be implemented as, or incorporated into, various devices such as a personal computer or portable electronic device such as a smart device. In one embodiment, the computer system 12 may include multiple computer systems communicably connected to one another or to a common client device 14.

The computer system 12 includes a processor 16 and a memory 18. The memory 18 is configured to store program instructions to be executed by the processor 16 causing the computer system 12 to perform operations indicated by the program instructions.

In one embodiment, the computer system 12, in response to execution of the program instructions by the processor 16, is configured to receive live event information regarding a live event, analyze the received live event information, and determine a delay status of the live event based on the analysis of live event information. In one embodiment, the computer system may also generate a message based on the determined delay status and transmit the generated message. In one embodiment, the computer system 12 is also configured to receive a request to monitor a particular event in order to determine a delay status of the particular live event. In one embodiment, the computer system 12 is also configured to monitor the live event information. The monitored live event information may then be analyzed to determine the delay status. In one embodiment, the computer system 12 is also configured to store one or more rules to be applied when analyzing the live event information, and the delay status may be determined based on the live event information and the one or more rules. In one embodiment, additional information regarding the live event information may be stored at the rules modules, and the delay status may be further determined based at on the additional information.

According to one embodiment, the live event information may be information relating to a televised live event, such as a sporting event, news broadcast, awards show, political debate, live concert, parade and other similar events broadcast in real-time or substantially real time. The live event information may vary depending on the type of live event.

In one embodiment, the live event information may be received by the computer system 12 from one or more data sources 34. In one embodiment the live event information may be stored in data fields 40 at the one or more data sources 34. In one embodiment, the live event information may be received at the computer system 12 in a same or similar format, i.e., stored in data fields 40. Accordingly, data fields 40 may be present at both the one or more data sources 34 and the computer system 12. In other embodiments, the live event information may be provided to the computer system 12 and organized in a predetermined manner.

The live event information may be received at the computer system 12 as a function of time, at predetermined time intervals, irregular time intervals, in response to a particular event, a push operation, a pull operation or the like. In one embodiment, the live event information may be received at about 10 second intervals. However, the interval may be increased or decreased as desired. In one embodiment, the live event information may be received substantially in real-time.

In one embodiment, the live event information may include one or more different types of information. For example, live event information may include fixed information regarding a particular live event that is not expected to change during the course of the live event, and active information that is expected to change during the course of the live event. For example, when the live event is a sporting event, the fixed information, stored in corresponding data fields 40, may include one or more of, but is not limited to, a date of the event, the teams participating in the event, the scheduled start time of the event, the type of sport, and a location of the event including, for example, the city or the venue in which the event is scheduled. Additional fixed information, stored in corresponding data fields 40, could include projected player lineups, player statistics to-date and other similar information.

Still referring to the sporting event example, the active information, stored in corresponding data fields 40, may include, but is not limited to, one or more of in-game player statistics, in-game player lineups, a current score to the game, in-game team statistics, weather, last play, current game status, game progress (e.g., time remaining, time played, period, quarter, half, inning information, and the like), and other active information which may be specific to a particular sport. The active information, stored in corresponding data fields 40, may include continuous information relating to live event information that is expected to change continuously, or substantially continuously during normal progression of the live event. Thus, a subset of data fields 40 for the active information may include the continuous information. The data field for the continuous information may vary depending on the particular sporting event or other live event, as described below.

Referring still to the sporting event example, the live event information may vary depending on the type of a sporting event. Although it is understood that the fixed information may vary by sport in some cases, the following examples relate primarily to the active information which may be associated with different sporting events.

For example, in a baseball game, the active information, stored in corresponding data fields, may include one or more of, but is not limited to: the score, the current inning, the number of outs, the current pitcher, the current batter, the current batting lineup, the current position lineup, available pitchers, available batters, other player and lineup information, player statistics, team statistics, the pitch count (pitches thrown), the batting count (balls/strikes) and the last play or pitch. Other active information and related data fields 40 may include the current status of the baseball game, such as, for example, a ball in play, a foul ball, awaiting a pitch, an end of an inning, an end of a half inning, a pitching change, runners on base, a rain delay and the like. Some information, such as information for the pitch count, may be considered to be continuous information.

The sporting event may also be a college or professional football game. In one embodiment, the active information, stored in corresponding data fields 40, may include, but is not limited to, one or more of: the score, the player lineup, time remaining in a quarter, half or game, the current quarter or half, player statistics, team statistics, down and distance, the last play, field position, time outs, the last play, possession information and the like. Other active information and related data fields 40 may include the current status of the football game, such as, for example, a change in possession, a scoring event (e.g., touchdown, field goal, extra point, safety), end of quarter, end of half, player injury, replay review, penalty, chain measurement, time out, and the like. It is understood that data fields relating to current status information may vary between college and professional football, or a particular league, as well. For example, in professional football, a current status may further include a two-minute warning. In one embodiment, information for the time remaining in a quarter may be considered to be continuous information. Information for the down and distance may also be considered to be continuous information.

In one embodiment, for professional and college basketball, the active information, stored in corresponding data fields 40, may include, but is not limited to, one or more of: the score, the player lineup, time remaining in a quarter (professional basketball), time remaining in a half (college basketball), player statistics, team statistics, the last play, time outs, team fouls, possession arrow (college) and the like. Other active information and related data fields 40 may include the current status of the basketball game, such as a time out (including a television time out), end of quarter, end of half, replay review, player injury and the like. In one embodiment, information for the time remaining in a quarter or half may be considered to be continuous information.

The active information, stored in corresponding data fields 40, for a hockey game may include, but is not limited to, one or more of: the score, the last play, player statistics, team statistics, the current period, time remaining in the period, the player lineup and the like. Other active information and related data fields 40 may include the current status of the hockey game, such as a frozen puck, offsides, puck out of play, player injury, penalties, time out, scoring event, replay review, end of a period and the like. In one embodiment, information for the time remaining in a period may be considered to be continuous information.

Although the examples above are described in relation to specific sporting events, it is understood that the present disclosure is not limited to such live events. For example, it is envisioned that data fields 40 for live event information may be provided for information in other sporting events, such as, but not limited to soccer, tennis, golf, automotive racing and the like. Likewise, data fields for live event information for other televised live events, including, but not limited to those described above may be provided as well.

In one embodiment the data fields 40 and related live event information may be stored at the one or more data sources 34. In another embodiment, the data fields 40 and the related live event information may be stored by the computer system 12, for example, in the memory 18.

In one embodiment, the computer system 12 may further include, for example, a receiving module 20, an output module 24, a determining module 28, and a message generating module 30. In some embodiments, the computer system 12 may further include one or more of a request module 22, a monitoring module 26 and a rules module 32. The modules of the computer system 12 may be connected on a bus 52 and controlled by the processor 16 in response to execution of the program instructions.

The receiving module 20 of the computer system 12 is configured to receive the live event information from, for example, the one or more data sources 34. In one embodiment, the computer system 12 may receive the live event information from a data source 34 such as a local, remote and/or third-party database. In one embodiment, the live event information may be input directly to the computer system 12, for example, with a peripheral device 36 such as a keyboard, pointing device, touch screen, microphone and the like. Additionally, or alternatively, the computer system 12 may also be communicably connected to a data source 34 through an Application Program Interface (API) 38, which may be connected to a database. Accordingly, the computer system 12 may receive the live event information from the API 38. In another embodiment, the live event information may be received at the computer system 12 in response to user input at a client device 14. For example, the live event information may be crowdsourced. In other embodiments, the computer system 12 may receive the live event information through various combinations of the above.

The determining module 28 is configured to analyze the live event information received at the receiving module 20, and further, to determine a delay status of the live event based on the analysis of live event information. In one embodiment, the determined delay status may indicate, for example, a commencement of a delay, an end of the delay and/or resumption of the live event after the delay.

In one embodiment, a type of live event may be known or determined based on the live event information, for example, by analyzing the data field types. Further, in one embodiment, the determining module 28 may analyze the continuous information of the live event information received at the receiving module 20. The determining module 28 may analyze the continuous information, sequentially received with respect to time, to determine whether the continuous information of a particular data field 40 has changed. For example, if the continuous information of the particular data field has not changed over a predetermined length of time, or after a predetermined number of updates, the determining module 28 may determine that a delay has commenced in the live event. After determining a delay has commenced, the determining module 28 may then continue to analyze the continuous information of the particular data field 40 for a change. When the determining module 28 determines that the continuous information of the particular data field 40 has changed, the determining module 28 may determine that the delay has ended and/or the live event has resumed.

For non-limiting illustrative purposes, in one embodiment, the determining module 28 may analyze a data field 40 having continuous information relating to the amount time remaining in a quarter of a football game. If the determining module 28 determines that the amount of time remaining in the quarter, as provided in the particular field 40, has not changed after a predetermined length of time, such as one minute, or that the time remaining has not changed after a predetermined number of updates or refreshes of the data field 40, the determining module 28 may determine that a delay has commenced in the football game. The determining module 28 may then continue to analyze the data field 40 relating to the time remaining in the quarter, and upon detecting a change in the time remaining, determine that the delay has ended and/or that the football game has resumed. In one embodiment, the determining module 28 may analyze other data fields as well to detect a change in the live event information of those data fields. Such a change may also indicate that the football game has resumed.

In some embodiments, different data fields 40 having different continuous information may be analyzed to determine the delay status. Further, in different types of live events, different data fields 40 related to different types of continuous information may be analyzed to determine the delay status. For example, in a baseball game, the determining module 28 may analyze a data field 40 for the pitch count to determine the delay status of the baseball game. In other embodiments, the determining module 28 may analyze multiple data fields, including data fields relating to other active information, not limited to continuous information, to determine the delay status. Further, in some embodiments, the determining module 28 may analyze multiple data fields 40 and cross-check the delay status determinations for each, to confirm a delay status.

Alternatively, or in addition, the determining module 28 may analyze a data field 40 containing active information relating to the current status of the live event. For example, the determining module 28 may analyze the current status information to determine if the current status is one that corresponds to a delay for the particular live event. As a non-limiting illustrative example, the determining module 28 may analyze a data field 40 having a current status of a baseball game. If the current status indicates that a pitching change is occurring, the determining module 28 may determine that a delay has commenced and is in progress. The determining module 28 may then continue to analyze the current status information for a change indicative of play resuming. For example, the determining module 28 may analyze a change from a current status indicating a pitching change to a current status indicating a ball in play or batter awaiting a pitch, and determine that the delay has ended or play has resumed. Alternatively, or in addition, the determining module 28 may analyze other data fields 40, such as data fields 40 relating to the batting count or pitch count, and based on a change in such data fields, determine that the delay has ended or play has resumed.

In one embodiment, the computer system 12 may include the rules module 32, configured to store one or more rules associated with the live event information for different live events. In one embodiment, the determining module 28 may analyze the live event information based on an associated one or more rules to determine the delay status. For example, a rule stored in the rules module 32 may provide that a delay has commenced if a particular data field 40 has not changed for a given length of time. As a non-limiting illustrative example, a rule may be stored for a basketball game providing that if a data field 40 containing continuous information, such as time remaining in a quarter, has not changed after a given length of time, then a delay has commenced. Accordingly, when analyzing the continuous information of a data field 40 for the time remaining in a quarter of a basketball game, the determining module 28 may determine the delay status based on the live event information (e.g., the continuous information) and the rule stored in the rules module 32.

The rules modules 32 may store additional rules which consider the live event information in a plurality of data fields. For example, the rule may provide that if continuous information for a time remaining in a quarter of a football game has not been updated, and that data fields for down and distance and possession have changed, that a delay, in the form of a television time out, has commenced relating to a change of possession. The rules module may include additional information relating to a delay as well, such as a known the length of particular type of delay (e.g., a time out, a television time out, time between quarters, halftime, and the like). Accordingly, the determining module 28 may determine that a delay has commenced and that the delay is expected to end and the live event is expected to resume upon expiration of the length of the delay, which was determined based on the additional information. A length of different, known or expected delays, may be known for a variety of live events. For example, a length of a television time out may be known based on contractual agreements between the broadcaster and the organizer of the live event. In other scenarios, the length of a delay may be known based on rules specific to the live event. For example, the length of a time out may be established in the rules for the particular sporting event. Similarly, a length between quarters, intermissions, and a length of halftime may be known as well. These examples are not exhaustive.

Alternatively, or in addition, the rules module 32 may store one or more rules relating to predetermined current statuses of different live events. For example, the determining module 28 may analyze a data field 40 containing information relating to the current status. The determining module 28 may compare the current status of the live event information to the predetermined current statuses stored in the rules module 32. If the current status matches a predetermined current status, additional information stored at the rules modules and associated with the current status may be retrieved and further analyzed by the determining module 28. In one embodiment, when a matching predetermined current status is found, the additional information may provide, or the determining module 28 may independently determine, that the current status is indicative of a delay, or conversely, is not indicative of a delay. The additional information may also indicate a known or expected length of the delay associated with the current status. The determining module 28 may then determine that a delay has commenced in the live event and that the delay is expected to end and the live event is expected to resume after expiration of the known or expected length of delay provided in the additional information.

In a non-limiting illustrative embodiment, the determining module 28 may analyze a data field 40 containing information relating to the current status of a professional football game. The current status may indicate that the football game is currently in the two-minute warning. The determining module 28 may compare the current status, i.e., the two-minute warning, to the predetermined current statuses stored in the rules module 32. Upon finding a matching predetermined current status, the determining module 28 may determine that a delay has commenced in the live event. Additional information relating the current status may also be retrieved and may indicate a length of the two-minute warning, set by league rules, to be two minutes. Thus, after determining a delay has commenced, the determining module 28 may further determine that the delay status will change, i.e., the delay is expected to end and that play is expected to resume, in two minutes, based on the additional information.

In one embodiment, the message generating module 30 is configured to generate a message based on the determined delay status. In one embodiment, the message generating module 30 is configured to generate a message in response to the determined delay status indicating that a delay has ended or that the live event has resumed. In such an embodiment, it assumed that the viewer, following the live event on television, is aware of a commencement of the delay.

The generated message may include, for example, one or more of texts, graphics, images, animations, videos, sounds, styles and the like, which may be stored in the memory 18, to provide a notification of the delay status. Alternatively, or in addition, the generated message may include program instructions to be executed by a client device 14 to provide a notification of the delay status. In one embodiment, the program instructions may be executed at the client device 14 to, for example provide a visual, audio, or tactile (including vibrating) notification of the delay status. In one embodiment, the message generating module 30 may generate different messages depending on the type of delay. The generated message may also include live event information from the data fields 40 containing fixed information including, for example, the type of live event and the participants. Active information may be included as well, to indicate, for example, a score in live sporting event.

In one embodiment, the output module 24 is configured to transmit the generated message to the one or more client devices 14 to provide a notification regarding the determined delay status, such as the start or end of a delay in the live event, or the resumption of the live event after a delay. The output module 24 is configured to communicate with the one or more client devices 14, for example, over a known communication network using know communication protocols and standards.

In one embodiment the computer system 12 may include the request module 22. The request module 22 is configured to receive a request from a client device 14 to monitor a particular live event. In response to receiving the request, the computer system 12 may determine a delay status of the particular live event based on the live event information. In one embodiment, the computer system 12 may request the live event information for the particular live event to be received at the receiving module 20. The computer system 12 may then analyze the live event information for the particular live event to determine the delay status.

In one embodiment, the computer system 12 further includes the monitoring module 26. The monitoring module 26 may be configured to monitor the live event information, for example, in response to a request to monitor a particular live event. In one embodiment, the monitoring module 26 may monitor data fields 40 of the live event information which are to be analyzed by the determining module 28 to determine the delay status. That is, in one embodiment, the monitoring module 26 may provide the live event information from only a subset of the data fields 40 used by the determining module 28 to determine the delay status. In one embodiment, the monitoring module 26 may monitor the data fields 40 for a change in the information contained in the data fields 40 and alert the determining module 28 to analyze the data fields 40 in response to the detected change. Conversely, the monitoring module 26 may monitor the data fields 40 and alert the determining module 28 to analyze the data fields 40 when a change has not been detected. In one embodiment, the monitoring module 26 may identify the type of live event information received at the receiving module 20, such as the fixed information or the active information.

The computer system 12 is not limited to determining a delay status based on the live event information. For example, the computer system 12 may be configured to provide substantially real-time status updates of the live events as well. For example, the computer system 12 may provide some or all of the live event information to client device 14 in a predetermined manner. In some embodiments, messages may be provided to one or more client devices indicating a change in live event information, such as a score of a sporting event, the start of a live event, the completion of the live event, or substantially real-time updates of the live event such that a user may track the live event via the client device 14.

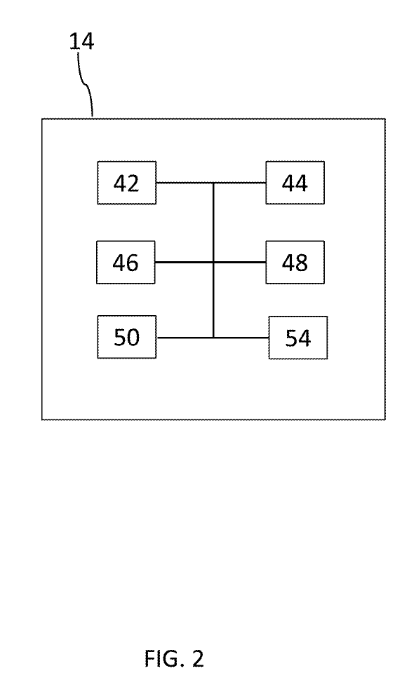

FIG. 2 is a block diagram of the client device 14 according to an embodiment described herein. In one embodiment, the client device 14 may be a portable electronic device, such as a mobile telephone or smartphone, a tablet, portable or laptop computer, a personal digital assistant (PDA), and the like. The client device 14 may also be various electronic entertainment devices such as a television, a gaming console, a video streaming device, or other home electronics such as a home artificial intelligence device (“home AI”) including connected voice-controlled speakers such as the ALEXA or ECHO sold by AMAZON, or the GOOGLE HOME, sold by GOOGLE. The client device 14 may also be a set top box, such as a satellite or cable television receiver configured to be connected to a television and provide a broadcast signal to the television. Other connected, electronic devices capable of communications with the computer system 12 are envisioned as well.

The client device 14 may include, be operably connected to, or both include and be operably connected to, at least one output device 42. Output devices 42 may include, but are not limited to, for example, display devices such as electronic display screens including mobile phone, computer, and television display screens, audio devices such as speakers, and vibrating devices such as a vibrating motor.

In one embodiment, the client device 14 includes the client device receiver 46, a client device memory 48 and a client device processor 50. The client device processor 50 is configured to execute program instructions stored in the client device memory 48 to control the client device 14 to perform functions according to the program instructions.

In one embodiment, the client device 14 is configured to receive the generated message from the computer system 12 over a suitable communication network. The client device 14 is configured to process the generated message and generate a notification based on the generated message. In one embodiment, the notification may be generated and provided based on the determined delay status contained in the message. Alternatively, or in addition, the information in the generated message may be used in, or provided as the notification. For example, in one embodiment, the generated message may include information to be included in the notification, such as the determined delay status, fixed information, for example, to identify the live event, and selected active information, for example, to provide an update of the live event. Other information in the generated message may be graphics, videos, sounds, text and the like. A program instruction included in the message may be executed by the client device processor 50 to generate and output the notification via one or more of the output devices 42. For example, the notification may be a visual notification output on the display device, an audio notification output on a speaker, and or a tactile notification output by a vibrating motor.

Alternatively, or in addition, the client device 14 may store a plurality of predetermined notifications. The message may include a program instruction to output a particular predetermined notification via one or more of the output devices 42. In another embodiment, the client device 14 may output a predetermined notification based on a delay status or other information contained in the message.

In one embodiment, the client device 14 may include, or be operably connected to, a tuning module 44. For example, in one embodiment, the client device 14 may be a television or a set top box which includes a tuning module 44. In another embodiment, the client device 14 may be a portable electronic device, such as a smart phone, or a home AI device, that may be operably connected to the tuning module 44 via a suitable communication network. In still another embodiment, the client device 14 may be a gaming console or video streaming device which includes, or is connected to, a television or other similar display.

In response to receiving the generated message, the client device 14 may also generate an instruction to control the tuning module 44. For example, in response to receiving a generated message having a determined delay status indicating that a delay has ended or the live event has resumed, or other predetermined information or instructions, the client device 14 may generate an instruction to control the tuner module 44 to change a station or channel to the station or channel broadcasting the live event.

As an illustrative, non-limiting example, the client device 14 may be a set top box configured to receive a message including the determined delay status. In response to a delay status indicating that a delay has ended in a particular live event, or that the particular live event has resumed, the set top box may generate an instruction to control the tuner module 44 to change the channel or station to the channel or station broadcasting the particular live event.

In another embodiment, the client device 14 may be the home AI device. The home AI device, in response to receiving the message, may provide an audio notification via an integrated speaker, based on the delay status. Alternatively, or in addition, the home AI device may generate and transmit an instruction to another device, communicably connected to the home AI device, to provide the notification. In still another embodiment, the home AI device may be operably connected to the tuner module 44 and may generate an instruction to control the tuner module 44 to change the station or channel based on the determined delay status, in the manner described above.

In one embodiment, the client device 14 may further include a client input device 54 through which instructions may be received and stored in the client memory 48. The input device 54 may be any known, suitable input device, including but not limited to, a keyboard, keypad, touchscreen, pointer, microphone or the like. In one embodiment, the client device 14 may receive an instruction to operate the tuning module 44 in response to receiving a determined delay status in the message. For example, the client device 14 may be the home AI device. The home AI device may receive a voice instruction through a microphone to change a channel to a particular live event when a determination is made, in the manner above, that a delay in the live event has ended or the live event has resumed. Accordingly, if such a voice instruction is received, in response to receiving the delay status, the home AI device may control a tuner module 44, for example, on a connected video streaming device, television, or set top box to change the channel or station to the channel or station broadcasting the particular live event.

In another example, a set top box may receive an instruction to change a channel in response to receiving a delay status. In one embodiment, the instruction may be received, for example, through a remote control having a microphone configured to receive a voice instruction. Accordingly, if such a voice instruction is received, in response to receiving the delay status, the set top box may control the tuner module 44 to change the channel or station to the channel or station broadcasting the particular live event.

In the embodiments described herein, the one or more data sources 34 and the computer system 12 may be integrated with one another, or may be connected to one another over a suitable communication network. In another embodiment, a client device 14 and the computer system 12 may be integrated with one another.

In the embodiments above, the client device 14 may communicate with the computer system 12 or other components, such as the output device 42 by sending and receiving radio frequency (RF) signals. The client device 14 may transmit or receive RF signals via an antenna, a transceiver, a SIM card and the like. The client device 14 is also configured to communicate over cellular telephone network, Local Area Network (LAN) including a Wireless Local Area Network (WLAN) and other wired and/or wireless communication networks. Wireless communications may use suitable technologies or protocols such as GSM, CDMA, Bluetooth, Near Field Communications, Wi-Fi (including IEEE 802.xx standards), VoIP and other similar protocols and standards facilitating wireless communication. The client device 14 may be connected to other devices or components of the system 10 or other systems either wirelessly, as described above, or through wired systems including, but not limited to, cable, fiber optic and/or standard telephone lines or known connection cables with, for example, pin or USB interfaces. The various devices and systems described herein may include input/output (I/O) devices to allow for communication with other devices or systems, including peripheral devices.

In both the client device 14 and the computer system 12, the memory is a computer-readable storage media. Computer-readable storage media include non-transitory media, for example, magnetic media, including hard disks and floppy disks; optical media including CD ROM disks and DVDs, and/or optical disks. Computer-readable storage media may also include hardware devices configured to store and/or perform program instructions, including read-only memory (ROM), random access memory (RAM), flash memory and the like. Further, computer-readable media may include Solid State Devices (SSDs) and remote or distributed memory devices or services. It is understood that non-transitory media does not include signals or waves.

Accordingly, in the embodiments above, a user/viewer may select a live event to monitor using the system 10. While the user is watching the live event on television, or via other media, such as a streaming media, the user may become aware of a delay which may result in, for example, a commercial break. When the computer system 12 determines a delay status indicating that the delay has ended, a message may be generated and transmitted to the client device 14. The client device 14 may then provide a notification to the user via the output device 42. The notification may indicate that the live event has resumed. In some embodiments, a tuning module 44 may be controlled to change a station or channel of a television, set top box, streaming device or the like, to the channel or station broadcasting the live event, in response to the determined delay status being received at the client device 14. Accordingly, a user of the systems or methods described herein may avoid missing substantial portions of the live event.

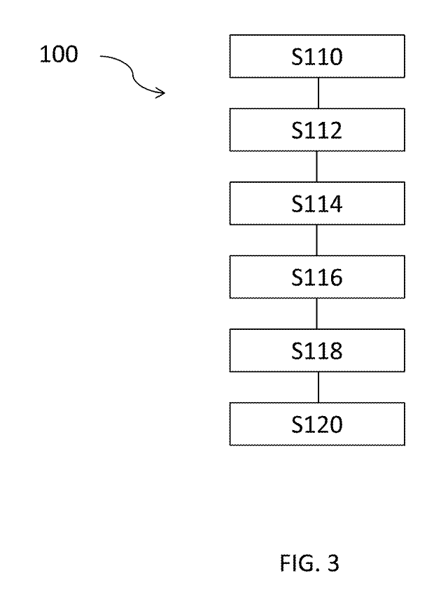

FIG. 3 is a block diagram showing an example of a method 100 of providing a delay status of a live event, according to one embodiment. In S110, the computer system 12 may optionally receive a request from a client device 14 to monitor a live event. The request may be received at the request module 22.

In S112, the computer system 12 may receive live event information, for example, from the data source 34. Alternatively, or in addition, the live event information may be received directly in the computer system 12 by way of manual input. In still another embodiment, the live event information may be received from user input at other client devices 14 in a crowdsourcing operation. The live event information may be received at the receiving module 20. The live event information may be, for example, fixed information, or active information including continuous information or current status information of the live event.

In S114, the computer system 12 may optionally monitor the live event information. For example, the monitoring module 26 may monitor sequentially received live event information.

In S116, the computer system 12 may analyze the received live event information and determine a delay status of the live event. The delay status may be, for example, the commencement of a delay, the end of a delay and/or the resumption of the live event. In one embodiment, the determining module 28 may determine the delay status based on live event information monitored by the monitoring module 26.

In one embodiment, the determining module 28 may analyze data fields 40 containing continuous information and determine whether the continuous information, as a function of time, corresponds to a delay in the live event. For example, if the continuous information does not change over period of time in which a change is expected, the determining module 28 may determine that a delay has commenced. After determining a delay has commenced, the determining module 28 may further analyze the continuous information, and in response to a change in the continuous information, may determine that the delay has ended or the live event has resumed. In another embodiment, the determining module 28 may analyze data fields 40 containing current status information to determine the delay status.

In another example, the determining module 28 analyze the live event information based on one or more rules stored at the rules module 32. In one embodiment, the determining module 28 may determine the delay status based on the live event information and the one or more rules. In addition, the rules module 32 may include additional information associated with the live event information. In one embodiment, the determining module 28 may determine the delay status based on the live event information, the one or more rules, and the additional information.

In S118, the computer system 12 may generate a message based on the determined delay status. For example, the message generating module 30 may generate a message to provide a notification of the delay status. In one embodiment, the message may be generated and transmitted to a client device 14, which may then display the message or otherwise output the message. In another embodiment, the message may include a program instruction, which when received at the client device 14, causes the client device 14 to provide a notification. For example, the program instruction in the generated message may cause a notification regarding the delay status to be displayed, or for an audio or tactile notification to be provided.

In S120, the computer system 12 may transmit the generated message to the client device 14. For example, the output module 24 may transmit the generated message to the client device 14.

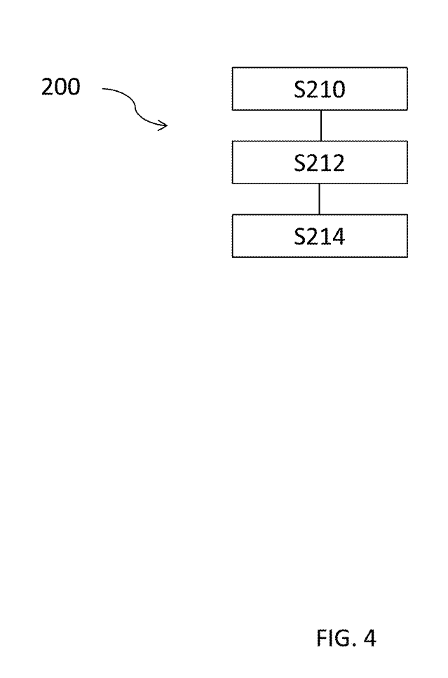

FIG. 4 is a block diagram showing an example of a method 200 of providing a live event notification, according to another embodiment. In S210, the client device 14 may send a request to a computer system 12 to regarding a particular live event to be monitored.

In S212, the client device 14 may receive a message generated by the computer system 12 based on a determined delay status of the particular live event. In one embodiment, the message includes a notification regarding the determined delay status. For example, the message may include notification that the delay has ended or that the particular live event has resumed. The notification may include one or more of text, graphics, animations, videos, sounds, vibrations and the like to be output by an output device 42 of the client device 14. For example, in one embodiment, the notification may be output as a display on a display device of the client device 14, output as a sound by a speaker device of the client device 14, or output as a vibration by a vibrating motor of the client device 14.

In one embodiment, the message may include program instructions configured to be executed by the client device processor 50 generate and output notification based on the determined delay status. The notification may be any of the notifications described above, and may be output, for example, by a display, speaker or vibrating motor of the client device 14. In one embodiment, the information may be output with the notification to indicate that the live event has resumed at a point in time after the scheduled start time.

In one embodiment, at S214, the client device 14 may be operably connected to a tuning module 44, for example, of a set top box, a television or a streaming device. In response to receiving a delay status indicating that a delay has ended or the live event has resumed, the client device 14 may control the tuning module 44 to change a channel or station to the channel or station which is broadcasting the live event.

While the examples above refer primarily to live sport events, it will be appreciated that the subject matter described herein may be used in conjunction with other live television events.

It is understood that the various embodiments described above may be combined and used together, or alternatively, may be used independently from one another. It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. A system for providing a notification of a live event, the system comprising:
a computer system comprising a memory configured to store program instructions and a processor configured to execute the program instructions, wherein the computer system, in response to execution of the program instructions, is configured to:
receive live event information regarding the live event;
analyze the received live event information;
determine a delay status of the live event;
generate a message based on the delay status; and
transmit the generated message, and
a client device communicably connected to the computer system and configured to receive the generated message, the client device including an output device configured to output a notification based on the generated message.

2. The system of claim 1, wherein the computer system is further configured to receive a request to monitor the live event.

3. The system of claim 1, wherein the computer system is further configured to monitor the received live event information, and the analysis of the received live event information is an analysis of the monitored live event information.

4. The system of claim 1, wherein the computer system stores one or more rules for analyzing the live event information and the delay status is determined at least in part on the basis of the one or more rules.

5. The system of claim 4, wherein the computer system further stores additional information associated with the live event information, and the delay status is further determined at least in part on the basis of the additional information.

6. The system of claim 1, wherein the live event information is stored in a plurality of data fields, and the plurality of data fields include one or more of data fields containing current status information and data fields containing continuous information.

7. The system of claim 1, further comprising a data source, wherein computer system is configured to receive the live event information from the data source.

8. The system of claim 1, wherein the delay status indicates that a delay in a live event has ended or that a live event has resumed.

9. The system of claim 8, wherein the client device is operably connected to, or includes, a tuning module configured to change a channel in response to receiving the generated message.

10. A computer system for determining a delay status of a live event comprising:
a memory configured to store program instructions;
a processor configured to execute the program instructions;
a receiving module configured to receive live event information regarding the live event; and
a determining module configured to analyze the live event information and determine a delay status of the live event.

11. The computer system of claim 11, further comprising:
a message generating module configured to generate a message based on the determined delay status; and
an output module configured to transmit the generated message.

12. The computer system of claim 11, further comprising a rules module configured to store one or more rules for analyzing the live event information and additional information associated with the live event information.

13. The computer system of claim 12, wherein the determining module is further configured to determine the delay status based on the additional information.

14. The computer system of claim 11, wherein the live event information is stored in a plurality of data fields, and the plurality of data fields include one or more of data fields containing current status information and data fields containing continuous information.

15. The system of claim 11, further comprising a request module configured to receive a request to monitor the live event and a monitoring module configured to monitor the received live event information.

16. A method for providing a notification regarding a delay status of a live event, the method executable by a computer system having a processor and a memory, the method comprising:
receiving live event information regarding a live event;
analyzing the received live event information; and
determining a delay status of the live event based on the received live event information.

17. The method of claim 16, further comprising:
generating a message based on the determined delay status; and
transmitting the generated message to a client device.

18. The method of claim 17, wherein the analyzing the live event information further comprises comparing the live event information to one or more rules stored in a rules module, and the determined delay status is further based on the one or more rules.

19. The method of claim 17, wherein the analyzing the live event information further comprises analyzing additional information associated with the live event information, and the determined delay status is further based on the additional information.

20. The method claim 17, further comprising monitoring the received live event information, wherein the determining of the delay status is based on the monitored live event information.
